(19) United States
(12) Patent Application Publication
(10) Pub. No.: US 2022/0078757 A1
(43) Pub. Date: Mar. 10, 2022

(54) METHODS, DEVICES AND COMPUTER READABLE MEDIUM FOR RESOURCE ALLOCATION IN SIDELINK TRANSMISSION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 17/419,563

(22) PCT Filed: Jan. 2, 2019
(86) PCT No.: PCT/CN2019/070138

§ 371 Date: Jun. 29, 2021

(51) Int. Cl. H04W 72/02; H04W 72/04; H04W 52/14

(52) U.S. Cl. CPC H04W 72/02; H04W 72/0446; H04W 52/14; H04W 72/0406; H04W 72/0453

(57) ABSTRACT

Embodiments of the present disclosure relate to methods, devices and computer readable mediums for resource selection. The method comprises determining, at the terminal device, available resources for a sidelink transmission in a predetermined time period; determining a power level for the sidelink transmission in the available resources; and selecting, from the available resources, a set of target resources for transmitting a signal using the power level. In this way, a low latency feedback is guaranteed and meanwhile a consistent transmission power will be maintained in the duration of the sidelink transmission.

### TECHNICAL FIELD

Embodiments of the present disclosure generally relate to the field of telecommunication, and in particular, to methods, devices and computer readable medium for resource allocation in sidelink transmission.

### BACKGROUND

In Agreements of RAN1#94bis, the Physical sidelink feedback channel (PSFCH) is defined and it is supported to convey Sidelink Feedback Control Information (SFCI) for unicast and groupcast via PSFCH. In this Agreement, at least Cyclic Prefix-Orthogonal Frequency Division Multiplexing (CP-OFDM) is supported.

Further, the coverage enhancement of Physical Sidelink Control CHannel (PSCCH), for example in a case of PSCCH and Physical Sidelink Shared Channel (PSSCH) multiplexing with the restriction that PSCCH and PSSCH use adjacent frequency resources, and the coverage enhancement of the Feedback channel will be further discussed.

### SUMMARY

In general, example embodiments of the present disclosure provide methods and devices for resource allocation in a sidelink transmission.

In a first aspect, there is provided a method implemented at a terminal device. The method comprises determining, at the terminal device, available resources for a sidelink transmission in a predetermined time period; determining a power level for the sidelink transmission in the available resources; and selecting, from the available resources, a set of target resources for transmitting a signal using the power level.

In a second aspect, there is provided a terminal device. The device comprises at least one processor; and at least one memory including computer program codes. The at least one memory and the computer program codes are configured to, with the at least one processor, cause the device at least to perform the method according to the first aspect.

In a third aspect, there is provided a computer readable medium having a computer program stored thereon which, when executed by at least one processor of a device, causes the device to carry out the method according to the first aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows a diagram of an example communication network 100 in which embodiments of the present disclosure can be implemented;

FIGS. 2A-2D show schematic diagrams of conventional structures for the resource allocation in a sidelink transmission;

FIG. 3 shows a flowchart of an example method 300 for resource allocation in a sidelink transmission according to some example embodiments of the present disclosure;

FIG. 4 shows a diagram of a structure of allocated resources in a sidelink transmission according to some example embodiments of the present disclosure;

FIG. 5 shows a diagram of a structure of allocated resources in a sidelink transmission according to some example embodiments of the present disclosure;

FIG. 6 shows a diagram of a structure of allocated resources in a sidelink transmission according to some example embodiments of the present disclosure;

FIG. 7 shows a diagram of a structure of allocated resources in a sidelink transmission according to some example embodiments of the present disclosure;

FIG. 8 shows a diagram of a structure of allocated resources in a sidelink transmission according to some example embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to any suitable device at a network side of a communication network. The network device may include any suitable device in an access network of the communication network, for example, including a base station (BS), a relay, an access point (AP), a node B (NodeB or NB), an evolved NodeB (eNodeB or eNB), a gigabit NodeB (gNB), a Remote Radio Module (RRU), a radio header (RH), a remote radio head (RRH), a low power node such as a femto, a pico, and the like. For the purpose of discussion, in some embodiments, the eNB is taken as an example of the network device.

The network device may also include any suitable device in a core network, for example, including multi-standard radio (MSR) radio equipment such as MSR BSs, network controllers such as radio network controllers (RNCs) or base station controllers (BSCs), Multi-cell/multicast Coordination Entities (MCEs), Mobile Switching Centers (MSCs) and MMEs, Operation and Management (O&M) nodes, Operation Support System (OSS) nodes, Self-Organization Network (SON) nodes, positioning nodes, such as Enhanced Serving Mobile Position Centers (E-SMLCs), and/or Mobile Data Terminals (MDTs).

As used herein, “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

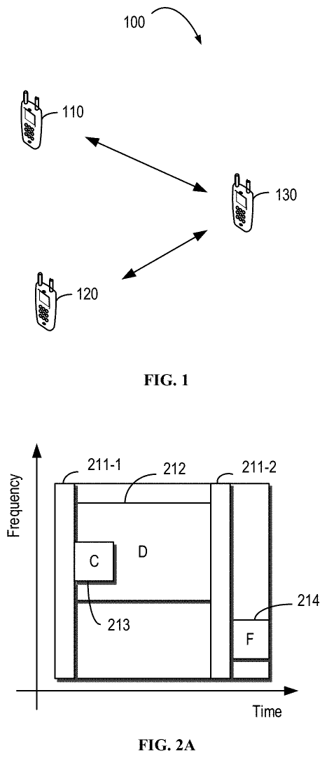

FIG. 1 shows an example communication network 100 in which embodiments of the present disclosure can be implemented. The network 100 may refer to a Device to Device (D2D) communication network. For example, the network 100 may be considered as a Vehicle-to-Everything (V2X) communication network which may include any combination of direct communication between vehicles, pedestrians, infrastructures, and networks, and thus can be divided into the following four different types: Vehicle-to-Vehicle (V2V), Vehicle-to-Pedestrian (V2P), Vehicle-to-Infrastructure (V2I), Vehicle-to-Network (V2N).

The network 100 may comprise terminal devices 110, 120 and 130. The terminal devices 110 and 120 may be considered as TX terminal devices and the terminal device 130 may be considered as RX terminal device. The terminal device 110 and 120 may communicate with the terminal device 130, respectively. The terminal device 110 may also communication with the terminal device 120. In this case, the terminal device 110 may be considered as a TX terminal device and the terminal device 120 may be considered as a RX terminal device. It would be appreciated that the number of terminal devices and the links there between are shown merely for illustration. There may be various other terminal devices in D2D communication in many other ways.

In the network 100, communication between terminal devices 110 and 120 can be performed via both Uu interface and direct links (or sidelinks). For the sidelink-based D2D or V2X communication, information is transmitted from a TX terminal device to one or more RX terminal devices in a broadcast manner.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

As described above, the TX terminal device (for example, terminal devices 110 and 120 shown in FIG. 1) may broadcast the Sidelink Control Information (SCI) to one or more RX terminal device via the Physical Sidelink Control CHannel (PSCCH) (for example, terminal device 130 shown in FIG. 1). The RX terminal device may receive and demodulate the Physical Sidelink Shared Channel (PSSCH) with the SCI. Besides the PSCCH and PSSCH, the physical structure of other short physical sidelink channel, for example, Physical Sidelink Feedback Channel (PSFCH) will be taken into consideration in sidelink transmission.

In general, only a part of the OFDM symbols available for the sidelink transmission in one slot may be used for the transmitting data or information via the short physical sidelink channel. Conventional, the PSFCH should be carried at the end of the slot and its presence should be signaled using SCI in the PSCCH. In the absence of Hybrid Automatic Repeat Request (HARQ) feedback in the slot, the whole slot is used for data transmission, which leads to increased resource utilization. Furthermore, the PSFCH is the sequence-based structure, since it can provide the required signaling without additional overhead for Cyclic Redundancy Check (CRC).

There are several options specified for the sidelink transmission. For example, the option 1 specifies that every slot has two guard periods, one in the beginning and one just before the channel carrying Sidelink Feedback Control Information (SFCI). The option 2 specifies that one guard period is introduced only when performing TX/RX switching. Furthermore, another options, i.e. the option A specifies that there is a exclusive time resource for the channel carrying SFCI and the option B specifies that within the time resource used by the channel carrying SFCI, the PSSCH of the same terminal device or other terminal device can occupy unused frequency resource.

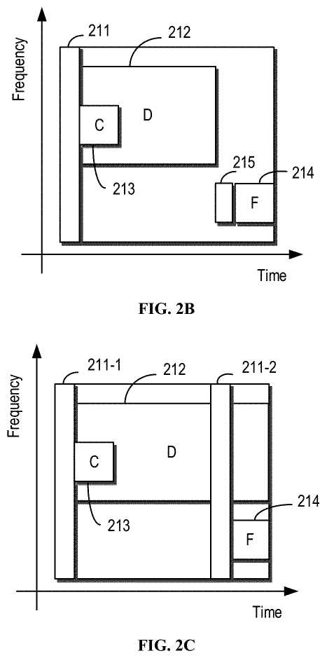

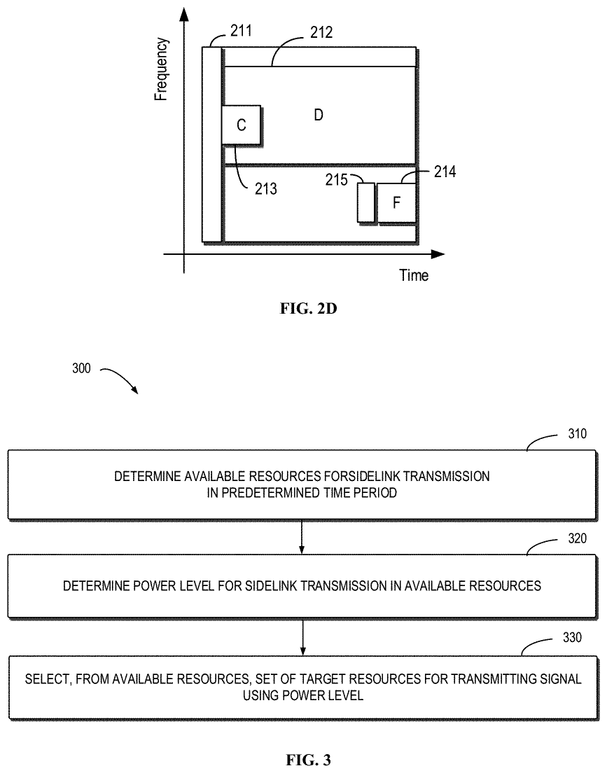

FIG. 2A-2D shows conventional structures for the resource allocation in a sidelink transmission. For example, FIG. 2A shows a case of the combination of the option 1 and the option A. The PSSCH 214 and the PSCCH 213 are multiplexed. There are two guard periods 211-1 and 211-2. The guard period 211-1 is located in the in the beginning and the guard period 211-2 is located before the channel carrying the SFCI 214. FIG. 2B shows a case of the combination of the option 1 and the option B, in which there is only one guard period 215 introduced when performing TX/RX switching.

Similarly, FIG. 2C and FIG. 2D show the case of the combination of the option 2 and the option A and the case of the combination of the option 2 and the option B, respectively. In both cases, within the time resource 214 used by the channel carrying SFCI, the PSSCH 212 of the same terminal device or other terminal device can occupy unused frequency resource.

In FIGS. 2A-2D, the power at the PSFCH symbols may be changed comparing to the PSSCH symbols.

In general, a low latency feedback requirement should be guaranteed in a short PSFCH duration. However, after the Automatic Gain Control (AGC) settling at the receiving terminal device, the reception power within one slot shall be unchanged, the duration of PSFCH has to be as long as one slot. Therefore, embodiments of the present disclosure propose to support low latency feedback and meanwhile prevent the impact on AGC settling by transmitting a signal for maintaining the transmission power in the duration of PSFCH. In this case, the resource allocation for the sidelink transmission will be further discussed as below. More details of the embodiments of the present disclosure will be discussed with reference to FIGS. 3 to 8.

Principle and implementations of the present disclosure will be described in detail below with reference to FIG. 3, which shows method 300 for the resource allocation for the sidelink transmission according to example embodiments of the present disclosure. The method 300 can be implemented at any of the terminal devices 110 and 120, which may be considered as a TX terminal device, as shown in FIG. 1. For the purpose of discussion, the method 300 will be described with reference to FIG. 1.

As mentioned above, the terminal device may transmit only a few OFDM symbols, for example, M OFDM symbols, in a slot. If there are N symbols that can be used for sidelink transmission in a slot, the terminal device 110 may transmit a signal for keeping power on the power keeping resources in the other N-M OFDM symbols.

As shown in FIG. 3, at 310, the terminal device 110 determines available resources for a sidelink transmission in a predetermined time period.

In some embodiments, the sidelink transmission may comprise may comprise a variety of types, for example, the sidelink transmission may be the sidelink control information transmission; the sidelink feedback information transmission; and the sidelink data transmission.

In some embodiments, the sidelink transmission may be performed via a sidelink physical channel comprising a PSCCH used for conveying SCI or a PSFCH used for conveying SFCI.

In some embodiments, the available resources for a sidelink transmission in a predetermined time period may be considered as all the OFDM symbols in a slot that can be used for sidelink transmission. The available resources for a sidelink transmission may be predetermined by the network device communication with the terminal device 110. Alternatively, the available resources for a sidelink transmission may be predetermined by the terminal device 120.

As shown in FIG. 3, at 320, the terminal device 110 determines a power level for the sidelink transmission in the available resources. As mentioned above, the power of the sidelink transmission, for example, in the entire slot, the power level should be unchanged. In some embodiment, the terminal device 110 may receive the power control information from the terminal device 130 or from a base station, which may indicate a set of power control parameters and/or power adjustment value for the sidelink transmission. The terminal device 110 may determine the power level based on the power control parameters and/or power adjustment value.

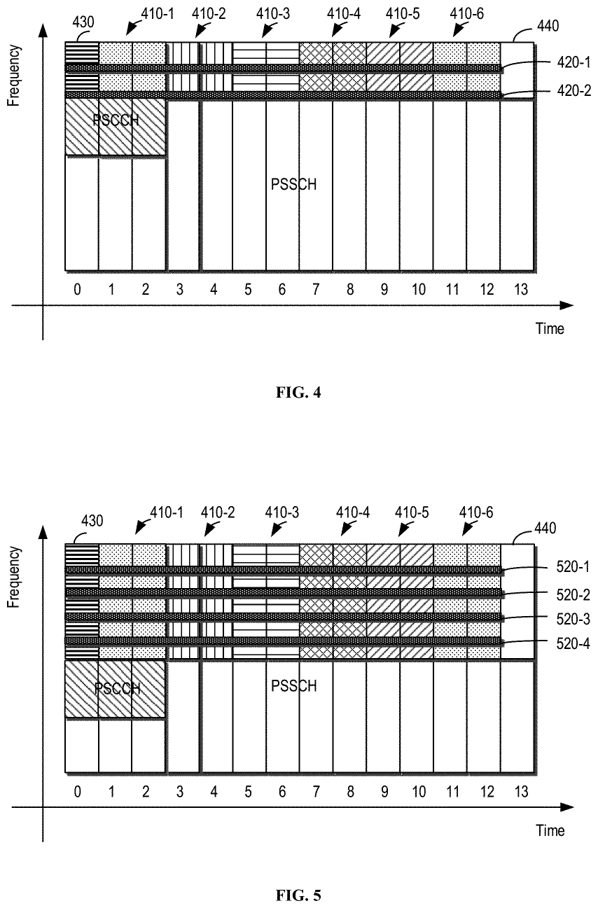

As shown in FIG. 3, at 330, the terminal device 110 selects, from the available resources, a set of target resources for transmitting a signal using the power level, which may maintain a consistent transmission power in the duration of the sidelink transmission. According to embodiments of the present disclosure, there are a variety of ways to determine the set of target resources. More details will be discussed with respect to embodiments of FIGS. 4-8.

FIG. 4 shows a diagram of a structure of allocated resources in a sidelink transmission according to some example embodiments of the present disclosure. With reference to FIG. 4, there are 14 OFDM symbols in a slot, namely 0^{th} symbol to 13^{th} symbol.

Assume that a terminal device may transmit a sidelink physical channel in OFDM symbol set S in a slot, the terminal device may also transmit one or more Power Keeping Signal (PKS) in power keeping resource (PKR) in OFDM symbol set R in the same slot. The OFDM symbol set S for transmitting a sidelink physical channel and the in OFDM symbol set R for transmitting one or more PKS are mutual exclusion and the union of the set S and the set R equals to set A. The set A may comprise all the OFDM symbols in a slot that can be used for sidelink transmission.

In FIG. 4, there are 6 PSFCHs, namely 410-1 to 410-6, for the sidelink transmission of different terminal devices. For example, the terminal device 110 may perform the sidelink transmission via PSFCH 410-1. Then, the set S for transmitting a sidelink physical channel by the terminal device 110 comprises the 1^{st} OFDM symbol and the 2^{nd} OFDM symbol and the set A may comprise all OFDM symbols from the 0^{th} OFDM symbol to 12^{th} symbol.

As shown in FIG. 4, the 0^{th} symbol may also be used for transmitting the AGC symbol 430 and the 13th symbol may be used as a gap symbol 440 for TX/RX switching. In some embodiments, the length of AGC symbol 430 and Gap symbol 440 can be as long as one OFDM symbol or less. In some embodiments, the AGC symbol 430 can be considered as part of the first PSFCH, PSFCH 410-1. That is, the terminal device 110 may also transmit SFCI on AGC symbol 430.

In some embodiments, the terminal device 110 may determine a transmission pattern indicating at least one predefined resource element (RE) for transmitting the power keeping signal in the available resources. Based on the transmission pattern, the terminal device 110 may select the set of target resources for transmitting the power keeping signal.

In some embodiments, for determining the transmission pattern, the terminal device 110 may determining at least one of the following of the total number of the at least one predefined RE; positions of the at least one predefined RE in time domain and in frequency domain and an index of the at least one predefined RE in all REs of the available resources.

For example, the transmission pattern may specify that the first RE of the first physical resource element (PRB) of the resource pool is used as the set of target resources for transmitting the power keeping signal, i.e. PKR.

Alternatively, the transmission pattern may specify that every k^{th} RE of a specific PRB may be used as the PKR. The factor k may be preconfigured. For example, as shown in FIG. 4, the REs of the 0^{th} symbol and the 3^{rd}-12^{th} symbols in the set of resources 420-1 and 420-2 may be used as the set of target resources for transmitting the PKS, i.e. the set R.

In some embodiments, for all TX terminal devices that transmitting PKS in multiple OFDM symbols of all OFDM symbols from the 0th OFDM symbol to 12th symbol, the frequency domain location of PKR in each OFDM symbol are the same. The power keeping signal may depend on the TX terminal devices with the restriction that the total transmission power of PKS in the OFDM symbol of set R should be the same as the transmission power of the UE in the OFDM symbol of set S.

In this case, the PKR in an OFDM symbol is not used for the sidelink physical channel and the DMRS transmission.

In some embodiments, the terminal device 110 may determine a reference resource set for transmitting a reference signal in the set of available resources for the sidelink transmission and determine, from the available resources, the set of target resources orthogonal to the reference resource set in frequency domain or non-overlap with the reference resource set in time domain. For example, the reference signal may be referred to as Demodulation Reference Signal (DMRS).

In some embodiments, if the terminal device 110 receives a further signal from a further terminal device 120 in the predetermined time period, the further signal indicating a further power level for a further sidelink transmission, the terminal device 110 may determine a set of occupied resources used by the further terminal device 120 for transmitting the further signal. The terminal device 110 may further determine, from the available resources, the set of target resources different from the set of occupied resources in frequency domain.

In some embodiments, the terminal device 110 may determine a reference resource set for transmitting a reference signal in the set of available resources for the sidelink transmission and determine, from the available resources, the set of target resources are the same as the reference resource set in frequency domain. For example, the reference signal may be referred to as Demodulation Reference Signal (DMRS).

FIG. 5 shows a diagram of a structure of allocated resources in a sidelink transmission according to some example embodiments of the present disclosure. As shown in FIG. 5, there are 6 PSFCHs, namely 410-1 to 410-6, each PSFCH resource may consist of 2 continuous OFDM symbols. For example, the PSFCH 410-1 may consist of the 1^{st} symbol and 2^{nd} symbol. The multiple PSFCHs 410-1 to 410-6 may be used by different terminal devices for transmit PSFCH on them, respectively, e.g. PSFCH 410-1 is used by terminal device 110, PSFCH 410-2 is used by terminal device 120, etc.

In this case, the location of PKR in each OFDM symbol of set A are the same as the location of DMRS REs for the physical sidelink channel. The location of PKR in each OFDM symbol may be common for all TX terminal devices. The PKSs transmitted by all TX terminal devices should be the same specific signal, e.g. a signal same as the DMRS of the sidelink physical channel.

As shown in FIG. 5, for example, the resource elements of resource set 520-1 to 520-4 may be the resource set for transmitting both DMRS and the PKS. For the 1^{st} symbol and 2nd symbol, the terminal device 110 may transmit DMRS on the REs for DMRS, with time domain cover code [1 1], and other TX terminal device, for example, the terminal device 120, may transmit PKS on the REs with time domain cover code [1-1].

As another example, if the multiple PSFCHs 410-1 to 410-6 in one PRB are used by different terminal devices, for the 1^{st} symbol and 2^{nd} symbol, the terminal device 110 may transmit DMRS on the REs for DMRS, with frequency domain cover code [1 1 1 1], and other TX terminal device, for example, the terminal device 120, transmit PKS on the REs with frequency domain cover code [1 −1 1 −1].

Alternatively, if the multiple PSFCHs 410-1 to 410-6 in one PRB are used by different terminal devices, for the 1^{st} symbol and 2^{nd} symbol, the terminal device 110 may transmit DMRS on the REs for DMRS, with time domain cover code [1 1] and frequency domain cover code [1 1 1 1], other TX terminal device, for example, the terminal device 120, transmit PKS on the REs with time domain cover code [1 −1] and frequency domain cover code [1 −1 1 −1].

FIG. 6 shows a diagram of a structure of allocated resources in a sidelink transmission according to some example embodiments of the present disclosure. Similarly with the case shown in FIG. 5, the location of PKR in each OFDM symbol of set A are the same as the location of DMRS REs for the physical sidelink channel. However, the location of PKR in each OFDM symbol may be different for different TX terminal devices.

For example, the resource elements of resource set 620-1 to 620-3 may be the resource set for transmitting the PKS for one group of terminal deice(s), and the resource elements of resource set 620-2 to 620-4 may be the resource set for transmitting the PKS for another group of terminal device(s).

Assume that there are three TX terminal device transmitting PSFCH, which use the PSFCHs 610-1 to 610-3, respectively. For example, the 0^{th} symbol may be used by the three terminal devices for transmitting the PKS, the 1^{st} to the 4^{th} symbols may be used by the second and the third terminal devices for PKS transmission, the 5th to 8th symbols may be used by the first and the third terminal devices for PKS transmission and the 9th to the 12th symbols may be used by the first and the second terminal devices for PKS transmission. In this case, for example the terminal device using PSFCH 610-1, it may transmit DMRS on the REs of the 1^{st} to the 4^{th} symbols with time domain cover code [1 1 1 1], and may transmit PKS on the REs of the 5^{th} to 8^{th} symbols and the 9^{th} to the 12^{th} symbols with time domain cover code [1 −1 1 −1].

Alternatively, still for this case, assume that there are three TX terminal device transmitting PSFCH, which use the PSFCHs 610-1 to 610-3, respectively. For example, the 0^{th} symbol may be used by the three terminal devices for transmitting the PKS, the 1^{st} to the 4th symbols may be used by the second and the third terminal devices, the 5th to 8th symbols may be used by the first and the third terminal devices and the 9th to the 12th symbols may be used by the first and the second terminal devices. In this case, for example the terminal device using PSFCH 610-1, it may transmit DMRS on the REs of the 1^{st} to the 4^{th} symbols with frequency domain cover code [1 1 1 1], and may transmit PKS on the REs of the 5^{th} to the 12^{th} with frequency domain cover code [1 −1 1 −1].

Alternatively, still for this case, assume that there are three TX terminal device transmitting PSFCH, which use the PSFCHs 610-1 to 610-3, respectively. For example, the 0^{th} symbol may be used by the three terminal devices for transmitting the PKS, the 1^{st} to the 4^{th} symbols may be used by the second and the third terminal devices, the 5th to 8th symbols may be used by the first and the third terminal devices and the 9th to the 12th symbols may be used by the first and the second terminal devices. In this case, for example the terminal device using PSFCH 610-1, it may transmit DMRS on the REs of the 1^{st} to the 4^{th} symbols with time and frequency domain cover code [1 1 1 1], and may transmit PKS on the REs of the 5^{th} to 8^{th} symbols and the 9^{th} to the 12^{th} symbols with time and frequency domain cover code [1 −1 1 −1].

In some embodiments, the location of PKR in each OFDM symbol may be FDMed for different terminal devices. In this case, the PKS transmitted by a terminal device should convey at least part of SCI or SFCI that supposed to be transmitted by the terminal device in the sidelink physical channel in set S. For example, the PKS can be a modulation symbol of some encoded SCI or SFCI bits, or PKSs can be the repetition of the sidelink physical channel transmitted by the terminal device in set S.

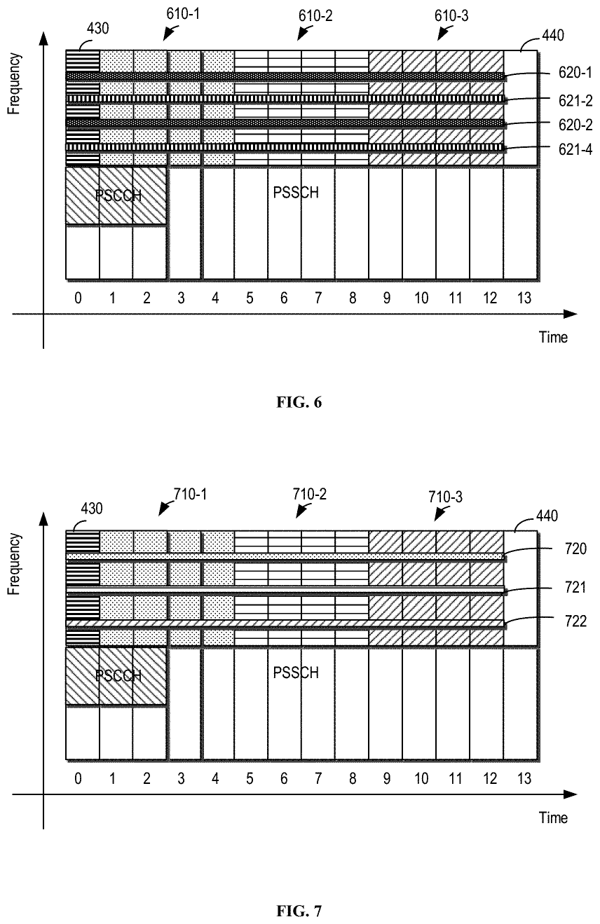

FIG. 7 shows a diagram of a structure of allocated resources in a sidelink transmission according to some example embodiments of the present disclosure.

Assume that there are three TX terminal device transmitting PSFCH, which use the PSFCHs 710-1 to 710-3, respectively. As shown in FIG. 7, the resource sets 720, 721 and 722 are used for transmitting the PKS by the first, second and third terminal devices, respectively.

The SFCI of the first terminal device to be transmitted in the slot are encoded and rate matched over all available REs in PSFCH 710-1 and available REs in PKRs for the first terminal device. In this case, the available REs are those for modulation symbol transmission, rather than the REs for DMRS. For the second terminal device and the third terminal device, the operations are same as described above.

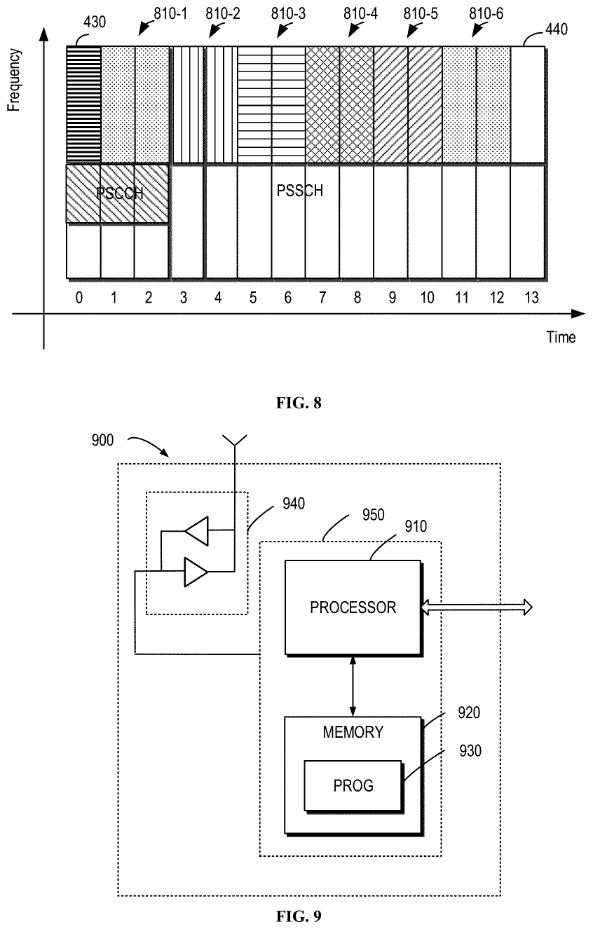

As another example, the PKSs can be the repetition of the sidelink physical channel transmitted by the terminal device in set S. FIG. 8 shows a diagram of a structure of allocated resources in a sidelink transmission according to some example embodiments of the present disclosure. As shown in FIG. 8, if the terminal device 110 transmits the PSFCH initially in the 1^{st} OFDM symbol the 2^{nd} OFDM symbol, i.e. in PSFCH 810-1, the terminal device 110 may transmits the same PSFCH repeatedly in 3^{rd} OFDM symbol to 13^{th} OFDM symbol, i.e. in PSFCH 810-2, 810-3, 810-4 and 810-5.

In some embodiments, the terminal device 110 may transmit the signal for keeping the power level using the selected set of target resources, i.e. the PKR.

In this way, a low latency feedback is guaranteed and a consistent transmission power will be maintained in the duration of the sidelink transmission.

FIG. 9 is a simplified block diagram of a device 900 that is suitable for implementing embodiments of the present disclosure. The device 900 can be considered as a further example implementation of a terminal device 110 or 120 as shown in FIG. 1. Accordingly, the device 900 can be implemented at or as at least a part of the terminal device 110 or 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIGS. 3 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 910 may form processing means 950 adapted to implement various embodiments of the present disclosure.

The memory 910 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 910 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method implemented at a terminal device, comprising:
determining, at the terminal device, available resources for a sidelink transmission in a predetermined time period;
determining a power level for the sidelink transmission in the available resources; and
selecting, from the available resources, a set of target resources for transmitting a signal using the power level.

2. The method of claim 1, wherein the sidelink transmission comprises at least one of the following:
sidelink control information;
sidelink feedback information; and
sidelink data.

3. The method of claim 1, wherein determining the power level comprises:
receiving power control information from a further terminal device communicated with the terminal device in the sidelink transmission, the power control information indicating at least one parameter associated with the power control; and
determining a power control algorithm; and
determining the power level based on the power control algorithm and the power control information.

4. The method of claim 1, wherein determining the power level comprises:
receiving power control information from a network device communicated with the terminal device, the power control information indicating at least one parameter associated with the power control; and
determining a power control algorithm; and
determining the power level based on the power control algorithm and the power control information.

5. The method of claim 1, wherein selecting the set of target resources comprises:
determining a transmission pattern indicating at least one predefined resource element for transmitting the signal in the available resources; and
selecting the set of target resources based on the transmission pattern.

6. The method of claim 5, wherein determining the transmission pattern comprises determining at least one of the following of:
the total number of the at least one predefined resource element,
positions of the at least one predefined resource element in time domain and in frequency domain, and
an index of the at least one predefined resource element in all resource elements of the available resources.

7. The method of claim 1, wherein selecting the set of target resources comprises:
determining a reference resource set for transmitting a reference signal in the set of available resources for the sidelink transmission; and
determining the set of target resources from the available resources, the set of target resources being the same as the reference resource set in frequency domain.

8. The method of claim 1, further comprising:
transmitting the signal using the set of target resources.

9. A terminal device, comprising:
at least one processor; and
at least one memory including computer program codes;
the at least one memory and the computer program codes are configured to, with the at least one processor, cause the device to perform acts comprising:
determining, at the terminal device, available resources for a sidelink transmission in a predetermined time period;
determining a power level for the sidelink transmission in the available resources; and
selecting, from the available resources, a set of target resources for transmitting a signal using the power level.

10. The device of claim 9, wherein the sidelink transmission comprises at least one of the following:
sidelink control information;
sidelink feedback information; and
sidelink data.

11. The device of claim 9, wherein determining the power level comprises:
receiving power control information from a further terminal device communicated with the terminal device in the sidelink transmission, the power control information indicating at least one parameter associated with the power control;
determining a power control algorithm; and
determining the power level based on the power control algorithm and the power control information.

12. The device of claim 9, wherein determining the power level comprises:
receiving power control information from a network device communicated with the terminal device, the power control information indicating at least one parameter associated with the power control;
determining a power control algorithm; and
determining the power level based on the power control algorithm and the power control information.

13. The device of claim 9, wherein selecting the set of target resources comprises:
determining a transmission pattern indicating at least one predefined resource element for transmitting the signal in the available resources; and
selecting the set of target resources based on the transmission pattern.

14. The device of claim 13, wherein determining the transmission pattern by comprises:
determining at least one of the following of:
the total number of the at least one predefined resource element,
positions of the at least one predefined resource element in time domain and in frequency domain, and
an index of the at least one predefined resource element in all resource elements of the available resources.

15. The device of claim 9, wherein selecting the set of target resources comprises:
determining a reference resource set for transmitting a reference signal in the set of available resources for the sidelink transmission; and
determining the set of target resources from the available resources, the set of target resources being the same as the reference resource set in frequency domain.

16. The device of claim 9, further comprising:
transmitting the signal using the set of target resources.

17. A computer-readable storage medium, having a computer program stored thereon, the computer program, when executed by a processor, performing acts comprising:
determining, at the terminal device, available resources for a sidelink transmission in a predetermined time period;
determining a power level for the sidelink transmission in the available resources; and
selecting, from the available resources, a set of target resources for transmitting a signal using the power level.

18. The computer-readable storage medium of claim 17, wherein the sidelink transmission comprises at least one of the following:
sidelink control information;
sidelink feedback information; and
sidelink data.

19. The computer-readable storage medium of claim 17, wherein determining the power level comprises:
receiving power control information from a further terminal device communicated with the terminal device in the sidelink transmission, the power control information indicating at least one parameter associated with the power control; and
determining a power control algorithm; and
determining the power level based on the power control algorithm and the power control information.

20. computer-readable storage medium of claim 17, wherein determining the power level comprises:
receiving power control information from a network device communicated with the terminal device, the power control information indicating at least one parameter associated with the power control; and
determining a power control algorithm; and
determining the power level based on the power control algorithm and the power control information.
